(19) United States
(12) Patent Application Publication
(10) Pub. No.: US 2009/0249491 A1
(43) Pub. Date: Oct. 1, 2009

(54) Contents Data, and Program, Apparatus and Method for Detecting and Controlling Unauthorized Contents

(76) Inventors: Nobuharu Miura, Urayasu (JP); Michiro Maeta, Tokyo (JP); Takaaki Yamada, Osaka (JP); Yoshiyasu Takahashi, Kawasaki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/342,132

(22) Filed: Dec. 23, 2008

(30) Foreign Application Priority Data
Dec. 26, 2007 (JP) 2007-333539

(51) Int. Cl. G06F 21/00

(52) U.S. Cl. 726/26; 707/100; 707/200; 707/3

(57) ABSTRACT

The problem to be solved is to allow anyone other than the contents license owner to acquire a right usage opportunity of contents while the fraud in the contents can be detected. To solve this problem, a contents ID, distribution media information specifying the distribution media of the contents, and identification information containing distribution period information specifying the distribution period of the contents are attached to the contents body When a contents acceptance module 140 receives the contents data, an acquisition pattern recognition unit 142 recognizes the acquisition pattern information of the contents data. A identification information extraction module 154 of a contents validity determination module 150 extracts identification information from the contents data. A validity determination unit 153 compares the condition specified by this identification information with the contents acquisition media and the acquisition period indicated by the acquisition pattern information and if the acquisition pattern information satisfies the condition specified by the identification information, the contents data is stored in the contents-for-distribution file 126. Additionally, if the contents are determined to be illegal a deletion request is sent to the requestor.

### FIELD OF THE INVENTION

The present invention relates to contents data, program, apparatus, and method preferred for illegal detection of contents.

### BACKGROUND OF THE INVENTION

Contents distributed over the WWW (World Wide Web) are increasing and changing on a daily basis. Contents search services that can automatically collect these contents and find the location of information are also now important services for users who browse the WWW.

Many commercial contents search services typically expose a keyword-searchable user interface in which contents are collected and keywords of the collected contents by those locations (URL: Uniform Resource Locator) are indexed using an automatic contents collection function (crawling function) called internet agents, crawlers, Web robots, etc. On the other hand, users acquire the location information of necessary information (i.e., URL) from the contents search service, and acquire the contents directly from the site on that location.

Initial contents search services do not carry contents itself, but provide only location thereof for users. However, for recent contents search services, it is also becoming common to accept contents posting (i.e., uploading) from users and redistribute the contents, and/or to collect the contents into a cache by using the automatic contents collection function and redistribute this contents itself. Essentially, since all created contents are automatically granted copyright under the copyright law, there are a wide variety of constraints to them, such as those that contents cannot be redistributed without the author's permission, and so on. Thus, for recent contents search services, as a result of contents redistribution, troubles about contents copyright are rapidly increasing.

Generally, it is difficult for the third party to identify whose works the contents are. Cases occur frequently that both authors fight for the copyright because the two works created absolutely independent of each other turn out to be similar. In addition, clearly malicious robbery, and cribbing affairs are occurring frequently.

As a technique that handles such troubles, one is disclosed in Japanese published patent application 2002-230207 (patent document 1).

This technique detects whether contents data are valid by matching identification information in the uploaded contents data with information managed by the identification information management unit. This identification information includes, other than contents ID for uniquely identifying the contents body, a person who has the license of this contents body, that is, a licensee of the copyright of the contents body, and the license period information, etc. as usage condition information of the contents body, so that when matching information, validity of the contents is determined by whether the submitter of the contents data accords with the licensee.

Note that as a conventional technology relating to such crawling function, one is described in Japanese published patent application 2002-312246 (patent document 2), and as a conventional technology relating to such uploading, another is described in Japanese published patent application 2001-76000 (patent document 3).

### SUMMARY OF THE INVENTION

However, although the technique disclosed in the patent document 1 can detect illegal in contents, it is extremely disadvantageous if, though the contents can be used only by particular persons such as the license owner, the contents author does not want the contents to be distributed, for example, with DVD (Digital Video Disc) or over the WWW, but want to allow the contents to be broadcasted at each broadcast station because the contents author has advantage for advertisement of the contents, characters, and objects in the contents, and if the contents author wants contents usage to be restricted during a certain period, but thereafter the contents to be open to the public, and so on.

That is, there is a problem that both techniques disclosed in the patent document 1 and techniques that restrict the number of copying operation times of contents focus on only contents usage restrictions and basically cannot handle a case that the contents author wants the contents to be used by the public.

Additionally, the relationship between problems classified by the kind of search services and the kind of contents described above and the conventional technology is shown in FIG. 16, and each has a problem shown in FIG. 17.

Therefore, the present invention focuses on these problems of such conventional technologies. An object of the present invention is to provide contents data, a program, an apparatus and a method that can present an opportunity of right contents usage to anyone other than the contents license owner according to an intention of contents author, etc. while detecting illegal in the contents.

To overcome the above problems, in the present invention, contents data is configured to include a contents body and identification information attached to the contents body, in which the identification information includes distribution pattern information that includes at least one of distribution period information indicating a distribution prohibition period or a distribution permission period of the contents body, and distribution media information specifying a distribution media of the contents body, and includes a contents identifier for uniquely identifying the contents body.

In view of the above description, the present invention causes a computer to perform steps of:

acquiring the contents data with a data acquisition means of the computer and storing the contents data in a contents storage area of the computer;

recognizing contents acquisition pattern information on acquiring the contents data at the step of acquiring the contents data;

extracting the identification information from the contents data stored in the contents storage area;

determining validity of whether the contents data is valid or illegal, by comparing the contents acquisition pattern information recognized at the step of recognizing contents acquisition pattern information with the distribution pattern information included in the identification information extracted at the step of extracting the identification information and in accordance with whether the contents acquisition pattern information satisfies the condition indicated by the distribution pattern information; and

storing the determination result at the step of determining validity in the storage area of the computer.

The present invention also provides in the FIG. 17 a means for solving the problems shown in the same figure.

According to the present invention, as identification information attached to the contents body, other than a contents ID uniquely identifying the contents body, distribution pattern information specifying the distribution pattern of the contents is included, so that as for a distribution pattern not specified by the distribution pattern information attached to the contents, anyone other than the contents license owner can also acquire a right usage opportunity of the contents while detecting the illegal in the contents.

### BRIEF DESCRIPTION OF THE DRAWINGS

FIG. 1 illustrates a schematic diagram of a contents illegal detecting system according to one embodiment of the present invention.

FIG. 2 illustrates a functional block diagram of the main section of a contents search apparatus and an identification information management apparatus according to one embodiment of the present invention.

FIG. 3 illustrates a functional block diagram of other main section of the contents search apparatus according to one embodiment of the present invention.

FIG. 4 illustrates a functional block diagram of still other main section of the contents search apparatus according to one embodiment of the present invention.

FIG. 5 illustrates a hardware configuration diagram comprising an identification information management apparatus, a right management apparatus, a distribution server, a distribution relay server, a user terminal, and a contents search apparatus according to one embodiment of the present invention.

FIG. 6 illustrates an explanatory diagram showing data configuration of a metadata database according to one embodiment of the present invention.

FIG. 7 illustrates an explanatory diagram showing data configuration of identification information according to one embodiment of the present invention.

FIG. 8 illustrates an explanatory diagram showing data configuration of a posted-contents-data file according to one embodiment of the present invention.

FIG. 9 illustrates an explanatory diagram showing data configuration of an business description database according to one embodiment of the present invention.

FIG. 10 illustrates a flowchart for controlling contents upload according to one embodiment of the present invention.

FIG. 11 illustrates a flowchart for contents certificate issuance process according to one embodiment of the present invention.

FIG. 12 illustrates a flowchart for cyclic contents monitoring process according to one embodiment of the present invention.

FIG. 13 illustrates a flowchart for accepting process of a contents delete request according to one embodiment of the present invention.

FIG. 14 illustrates an explanatory diagram showing data configuration of a certificate according to one embodiment of the present invention.

FIG. 15 illustrates a flowchart for contents certificate issuance process according to a variant of one embodiment of the present invention.

FIG. 16 illustrates an explanatory diagram showing a relationship between each conventional technology and classified problems.

FIG. 17 illustrates an explanatory diagram showing problems of each conventional technology in FIG. 16 and a means for solving the problems according to the present invention.

### DETAILED DESCRIPTION OF THE EMBODIMENTS

The followings describe an embodiment of a contents-illegal (fraud) detecting system according to the present invention with the accompanying drawings. Note that, in the followings, data having a contents body and identification information attached to the contents body is referred to as contents data, and unless otherwise noted, this contents data will be simply referred to as contents.

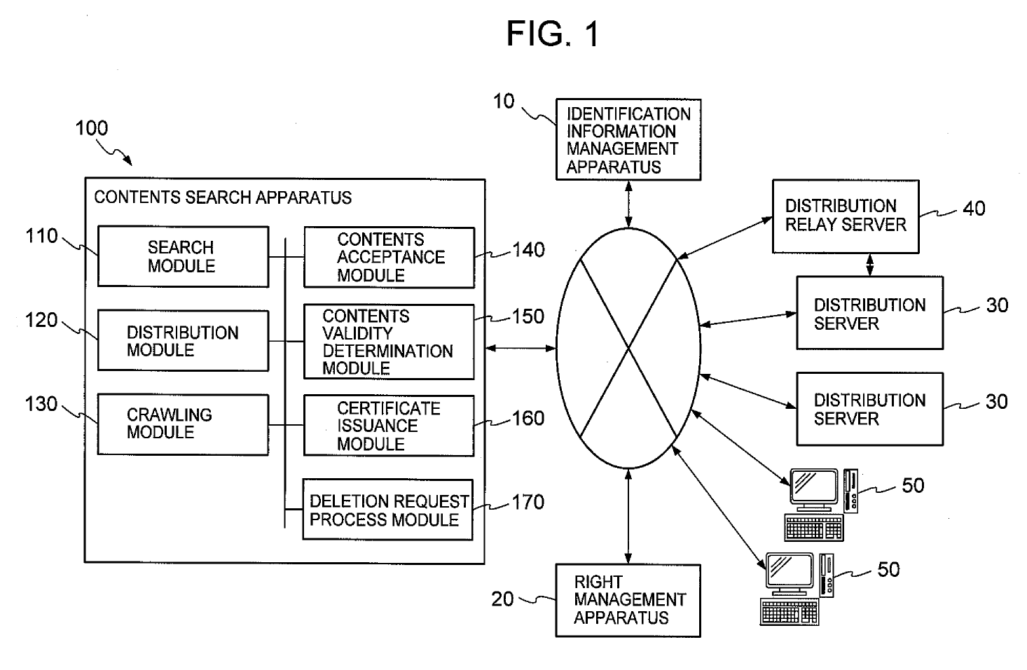

An illegal detecting system according to the embodiment comprises, as shown in FIG. 1, a contents search apparatus 100 that constitutes a contents illegal-detecting apparatus, an identification information management apparatus 10 that manages identification information of contents data, and a right management apparatus that manages the rights about the contents.

The contents search apparatus 100 and the identification information management apparatus 10 and the right management apparatus 20 are communicatively connected to one another over network. A plurality of distribution servers 30 that distribute each type of contents data, a distribution relay server 40 for decreasing the load on the distribution servers 30, and a plurality of user terminals 50 that access to the contents search apparatus 100 and the distribution server 30, etc. are connected to the network. The distribution relay server 40 functions as load balancing for the distribution server 30 when concurrent access grows and as a portal when users are spread on the network. Note that various contents such as moving images, still images, programs, text, music, computational data, etc, are included in the contents handled by the contents search apparatus 100, the distribution server 30, the distribution relay server 40 thereof, etc.

The contents search apparatus 100 comprises a search module 110 that searches a contents location (URL) in response to a request from the user terminal 50, a distribution module 120 that distributes contents, a crawler module 130 that sequentially acquires contents from a plurality of distribution servers 30, etc., a contents acceptance module 140 that accepts contents from the user terminal 50, etc., a contents validity determination module 150 that determines validity of contents, a certificate issuance module 160 that issues a certificate indicating validity of contents, a deletion request processing module 170 that processes a request from outside for deleting contents.

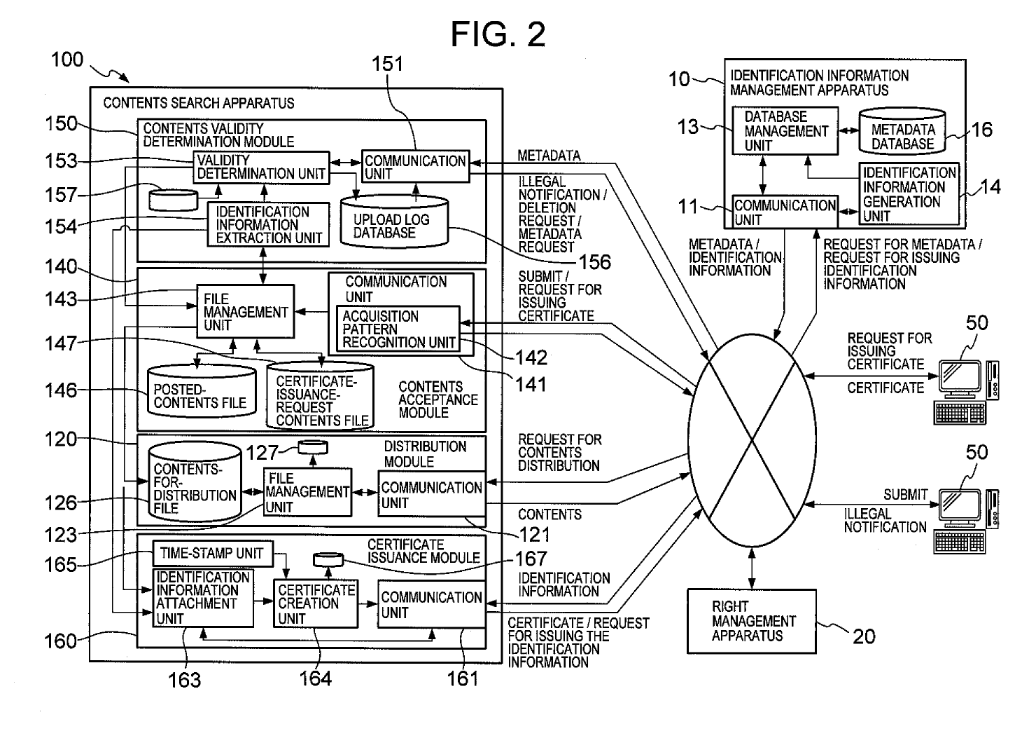

The contents acceptance module 140 comprises, as shown in FIG. 2, a communication unit 141 that accepts posted contents and a content associated with a request for issuing a certificate, a posted-contents file 146 in that posted contents will be stored, a contents file 147 for a certificate issuance request in that a content associated with a request for issuing a certificate will be stored, a file management unit 143 that controls storing/reading data in/from each file 146, 147.

The communication unit 141 comprises an acquisition pattern recognition unit 141 that recognizes an acquisition pattern on acquiring posted contents and a content associated with a request for issuing a certificate. As shown in FIG. 8, contents acquisition pattern information about the posted contents will be associated with the contents data as well as the posted contents data, and stored in the posted-contents file 146 by the file management unit 143. This contents acquisition pattern information includes the communication address of a contents submitter, the time of acquisition of the contents, and an acquisition media for the contents. Additionally, contents acquisition pattern information about the contents associated with a request for issuing a certificate will also be stored in the contents file 147 for a certificate issuance request as well as the contents data by file management unit 143. Although both contents acquisition pattern information and contents data are stored here in the same file, they may be associated with each other and stored in separate files respectively.

The contents validity determination module 150 comprises a communication unit 151 that communicates with outside, a identification information extraction unit 154 that extracts identification information from contents data, a validity determination unit 153 that determines validity of contents data such as by comparing this identification information with the contents acquisition pattern information described above, an upload log database 156 in that determination results etc. are stored, and a business description database 157 in that the business description of the contents submitter is pre-stored.

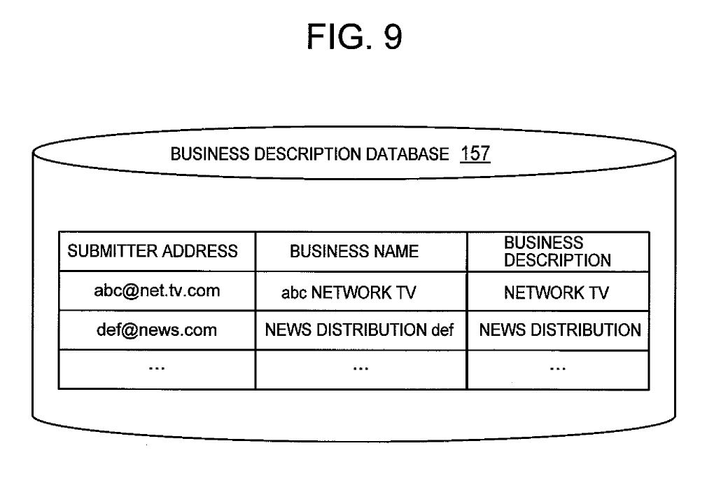

As shown in FIG. 9, the communication address of the submitter, the business owner name, the business description of the business owner are associated with one another and stored in the business description database 157.

The distribution module 120 comprises a contents-for-distribution file 126 that stores therein a content for distribution, a file management unit 123 that reads data from this file 126, a communication unit 121 that distributes a content corresponding to a request while accepting a contents distribution request from outside, and a distribution record file 127 in which distribution record of contents is stored.

The certificate issuance module 160 comprises an identification information attachment unit 163 that attaches identification information to the contents body of a content that is accepted along with a request for issuing a certificate by the contents acceptance module 140 and is determined to be valid by the contents validity determination module 150, a certificate creation unit 164 that creates a certificate indicating validity of this contents, a time-stamp unit 165 that outputs date-time data to be recorded in the certificate, a communication unit 161 that issues the certificate to the requester, and an issuance record file 167 that stores therein an issuance record of the certificate.

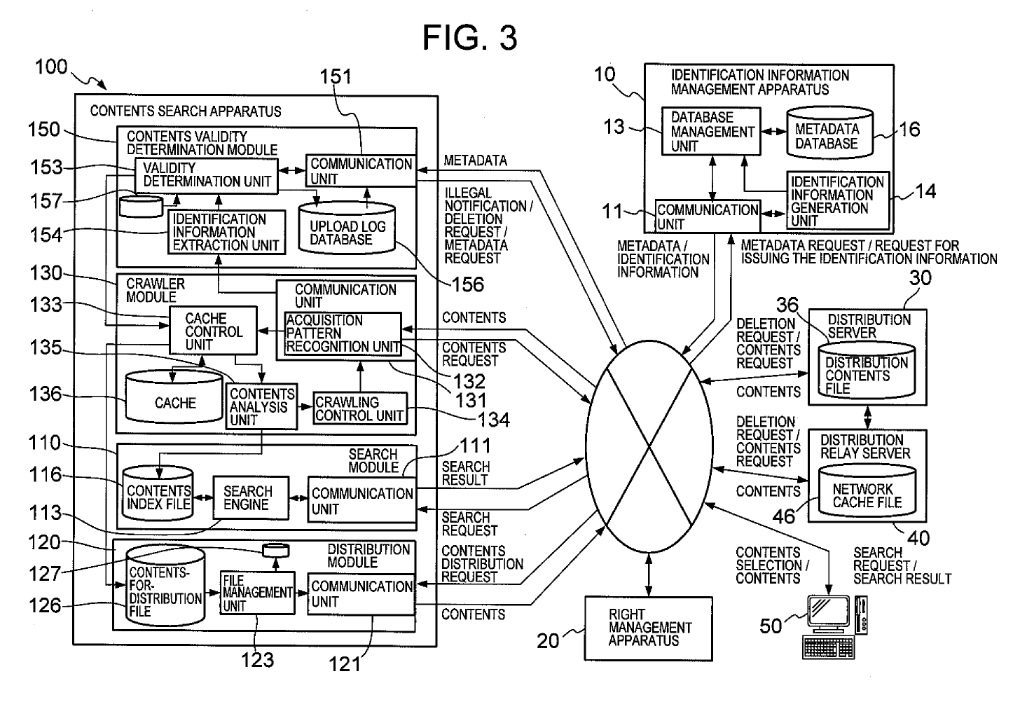

The crawler module 130 comprises, as shown in FIG. 3, a communication unit 131 that crawls a plurality of the distribution servers 30 etc. and accepts contents from each server, a crawling control unit 134 that controls crawling for this communication unit 131, a cache 136 that stores the contents accepted by the communication unit 131, a cache control unit 133 that controls storing/reading data in/from this cache 136, and a contents analysis unit 135 that, by analyzing the contents accepted by the communication unit 131, indexes keywords etc. included in the contents and a URL indicating the location in which this contents exists.

The search module 110 comprises a contents index file 116 in which these keywords etc. and a URL indicating the location in which a content including these keywords etc. exists are associated and stored, a communication unit 111 that accepts a search request from outside and returns the search result, and a search engine 113 that outputs a search result corresponding to the search request accepted by the communication unit 111.

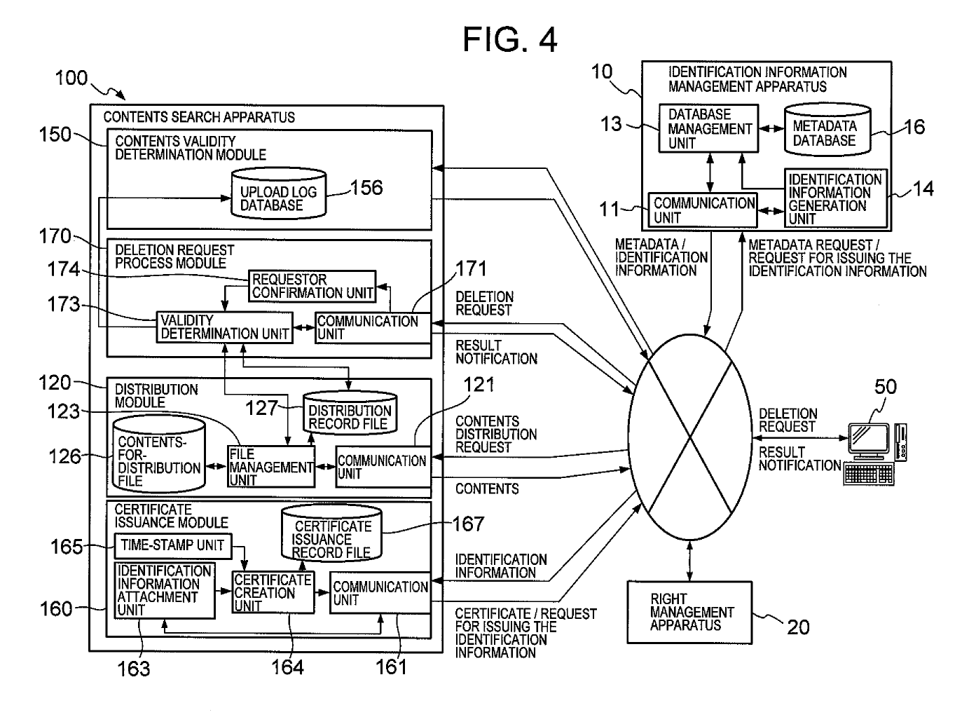

The deletion request processing module 170 comprises, as shown in FIG. 4, a communication unit 171 that accepts a request for deleting a content from outside and reports the result, a requestor confirmation unit 154 that confirms whether the deletion requestor is the same person who requests deletion, and a validity determination unit 153 that determines validity of the deletion request of the contents, and if the request is valid, then deletes the requested contents.

The identification information management apparatus 10 comprises a metadata database 16 that stores therein metadata including identification information of a content, a communication unit 11 that accepts a metadata request and a request for issuing identification information, an identification information generation unit 14 that creates identification information in response to acceptance of the request by the communication unit 11, and a database management unit 13 that controls storing/reading data in/from the metadata database 16.

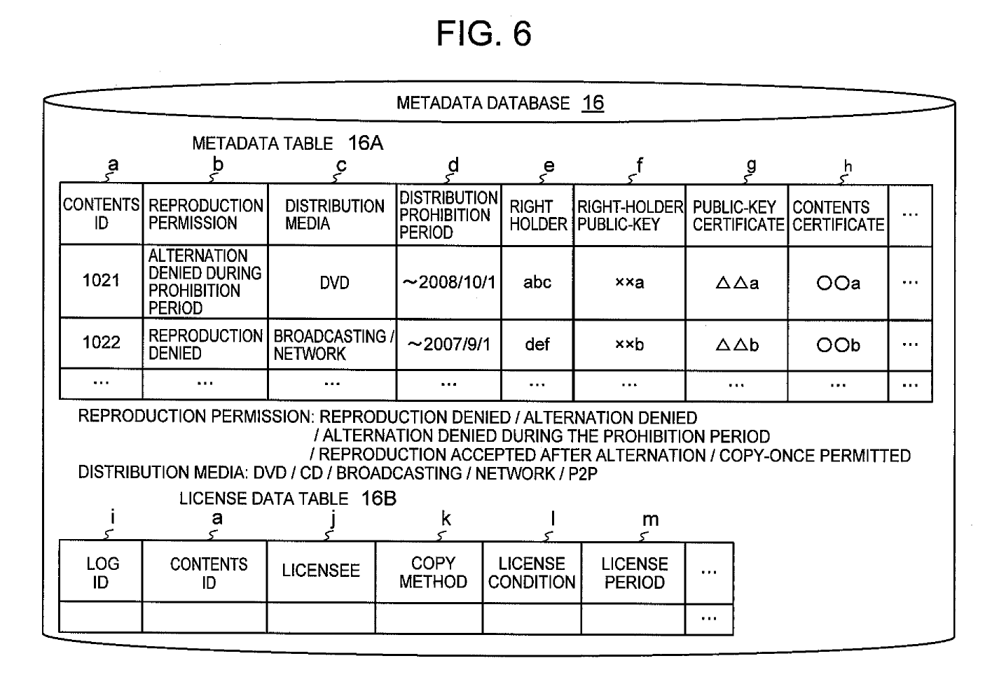

As shown in FIG. 6, a metadata table 16A and a license data table 16B are configured in the metadata database 16.

The metadata table 16A comprises a contents ID field a that stores therein a contents ID for uniquely identifying the contents body, a reproduction permission field b that stores therein reproduction permission of the contents, a distribution media field c that stores therein a distribution media that permits distribution of the contents, a distribution prohibition period field d that stores therein distribution prohibition period of the contents, a right holder field e that stores therein a right holder (i.e., author) of the contents, a right-holder public-key field f that stores therein a public key for the right holder, a public-key certificate field g that stores therein a certificate of the public key, and a contents certificate field h that stores therein a certificate to indicate validity of the contents. Note that though not illustrated here, there are other fields, such as data size, a representative diagram, feature quantity (e.g., features of keywords and images, etc.) of the contents body, and data format.

The reproduction permission field b stores therein either value of: reproduction denied, alternation denied, alternation denied during the prohibition period, reproduction accepted after alternation, copy-once permitted. In addition, the distribution media field c stores therein the kind of a distribution media for contents such as DVD, CD, broadcasting, network. For example, it is illustrated that for the contents body with contents ID “1021” stored in the first record shown in FIG. 6, alternation during the distribution prohibition period is not permitted, and even during the distribution prohibition period, distribution is permitted and the distribution time limit is Oct. 1, 2008 if the distribution media is DVD.

Note here, although a distribution prohibition period is configured in which distribution is not permitted as an example of distribution period, on the contrary a distribution permission period in which distribution is permitted may be configured. Also, although the distribution period here (distribution prohibition period or distribution permission period) is a period applied to all of the distribution media except for the distribution media that are stored in the distribution media field c, the distribution period may be configured for each distribution media.

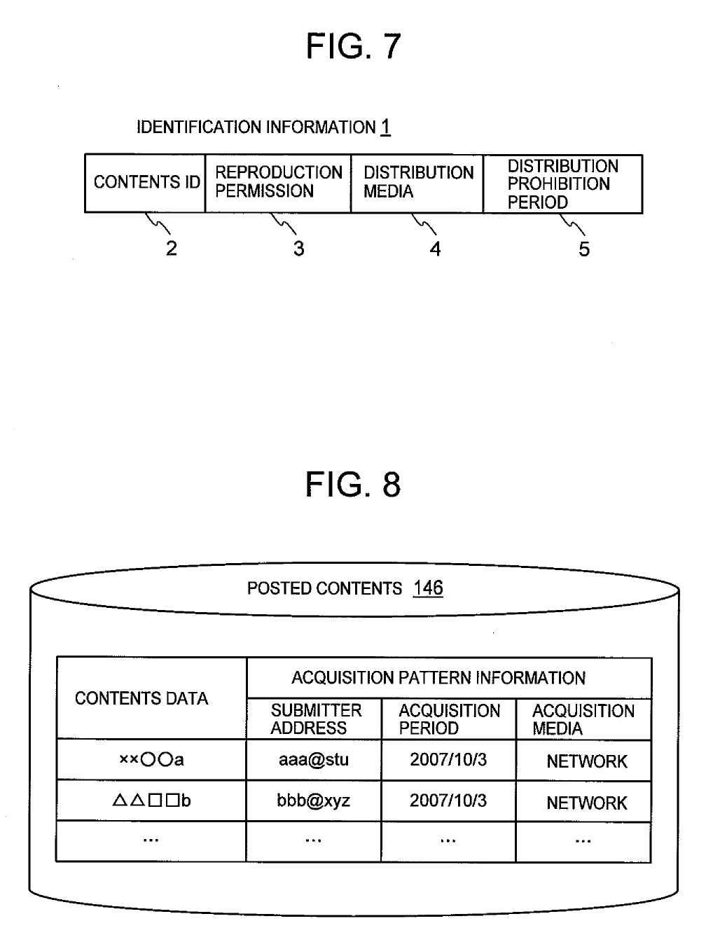

As shown in FIG. 7, identification information 1 attached to the contents body is configured to include a contents ID 2, a reproduction permission 3, a distribution media 4, and a distribution prohibition period 5. That is, the identification information 1 is configured to include a contents ID stored in contents ID field a of the metadata table 16A, reproduction permission stored in the reproduction permission field b, a distribution media stored in the distribution media field c, and a distribution prohibition period stored in the distribution prohibition period field d.

The license data table 16B comprises a log ID field i that stores therein a log ID, a contents ID field a that stores therein a contents ID, a licensee field j that stores therein a licensee, a copy method field k that stores therein a copy method, a license condition field l that stores therein a license condition, and a license period field m that stores therein a license period.

The copy method field k stores therein a specific aspect of the copy method, such as “only copy once in P2P transmission.” In addition, the license condition field l stores therein a wide variety of license conditions, for example, “reproduction not permitted”, “licensed for profit” even when reproduction is permitted.

Although the data stored in the license data table 16B is basically a kind of contents metadata, since conditions applied only to a particular person i.e. a licensee are stored in the table, here a table 16B different from the metadata table 16A described above will be configured, and the data will be managed in the table 16B. However, it should be understood that this license data table 16B and the metadata table 16A may be integrated into one table.

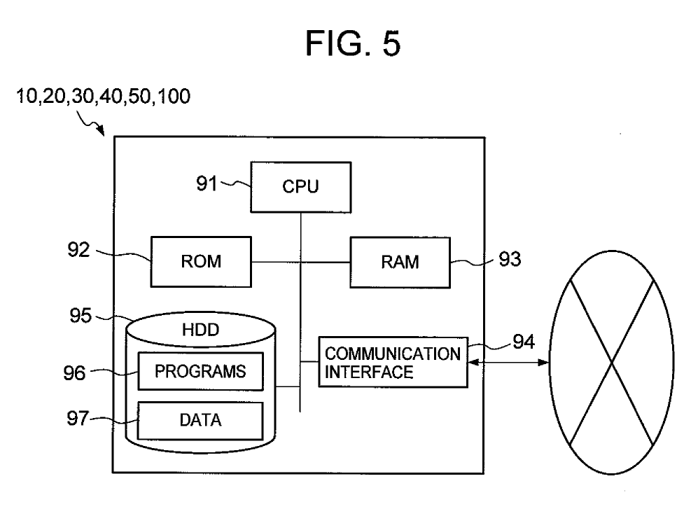

As shown in FIG. 5, both the contents search apparatus 100 and the identification information management apparatus 10 described above are computers, and configured to include a CPU 91 that performs various arithmetic operations, a ROM 92 that preliminarily stores therein various data or programs etc., a RAM 93 that is used as a CPU 91 work area, etc., a communication interface 94, a storage apparatus 95 such as a hard disk drive. The storage apparatus 95 stores therein various programs 96 or various data 97.

Among functional elements of the identification information management apparatus 10 and the contents search apparatus 100, the database management unit 13, the identification information generation unit 14, the search engine 113, the file management unit 123 and 143, the cache control unit 133, the validity determination unit 153 and 173, the identification information attachment unit 163, the crawling control unit 134, the contents analysis unit 135, the identification information extraction unit 154, the certificate creation unit 164, the requester confirmation unit 174, and time-stamp unit 165 are all configured to have the storage apparatus 95 described above and the CPU 91 that executes programs stored in the storage apparatus 95. Additionally, each communication unit 11, 111, 121, 131, 141, 151, 161, 171 are all configured to have the communication interface 94, the storage apparatus 95, the CPU 91 that executes programs stored in this storage apparatus 95. Each file and database is also configured to have the storage apparatus 95.

Note that, in this embodiment, an example in which the contents search apparatus 100 is configured with a single computer, but it may be configured with an individual computer for each module 110, 120, 130, 140, 150, 160, 170, and further, one module may be configured with multiple computers, and some of the modules may be configured with a single computer.

Additionally, the right management apparatus 20, each distribution server 30, 30, etc., the distribution relay server 40, each user terminal 50, 50, etc. shown in FIG. 1 are also configured with the computer shown in FIG. 5.

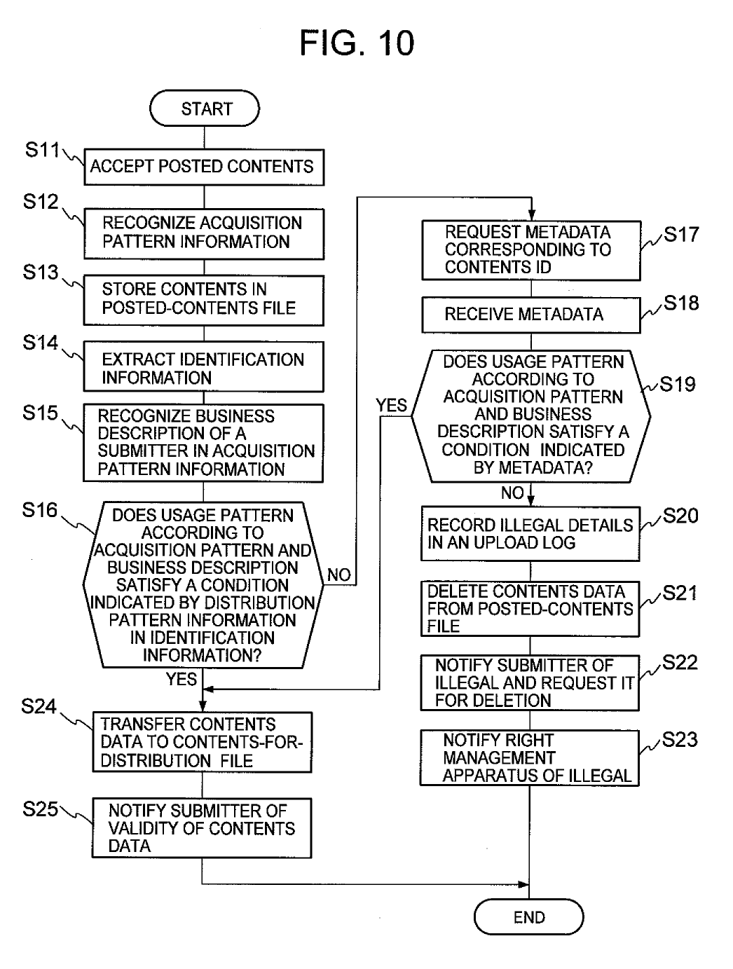

With reference to FIG. 2, then a content upload control method will be described in accordance with the flowchart illustrated in FIG. 10.

First, the user terminal 50 posts contents data to the contents search apparatus 100 and the communication unit 141 of the contents acceptance module 141 receives it (S11). Then, on accepting the posted contents data, an acquisition pattern recognition unit 142 of this communication unit 141 recognizes acquisition pattern information of this posted contents data, that is, the submitter address of the contents data, acceptance time (i.e., acquisition time), and the acquisition media (S12).

The file management unit 143 of the contents acceptance module 140 receives the posted contents data and the acquisition pattern information thereof from the communication unit 141, then stores them in the posted-contents file 146 (see FIG. 8) (S13). The file management unit 143 further passes the posted contend data stored in the posted-contents file 146 and acquisition pattern information thereof to the contents validity determination module 150.

The identification information extraction unit 154 of the contents validity module 150 extracts identification information from the posted contents data passed from the contents acceptance module 140 (S14). Next, the validity determination unit 153 of the contents validity module 150 refers to an business description database 157 and recognizes the business description of the submitter business provider indicated by the submitter address of the posted contents within the acquisition pattern information passed from contents acceptance module 140 (S15). Note that if the submitter address within the acquisition pattern information is not stored in the business description database 157, the submitter business provider will be considered as an individual herein. Then, the validity determination unit 153 determines whether the acquisition pattern indicated by the acquisition pattern information and the usage pattern according to the business description satisfy the condition indicated by the distribution pattern information in the identification information extracted previously.

Specifically, if “DVD” is designated as the distribution media and “until Oct. 1, 2008” is designated as the determination prohibition period in the distribution pattern information in the identification information, when the acquisition time in the same acquisition pattern information is “Oct. 3, 2007”, the acquisition pattern information does not satisfy the condition indicated by the distribution pattern information because the posted contents data are acquired via a network other than DVD, although it is almost a year before the distribution prohibition period expires. In other words, it is determined that the posting operation of the posted contents data is not a posting operation that satisfies the condition indicated by the distribution pattern information. An example in which a usage pattern according to the business description does not satisfies the condition indicated by the distribution pattern information will be described below.

If the validity determination unit 153 determines that the acquisition pattern indicated by the acquisition pattern information and the usage pattern according to the business description do not satisfy the condition indicated by the distribution pattern information (NO at step 16), it causes the communication unit 151 to make a request to the identification information management apparatus 10 to send metadata corresponding to the content ID included in the identification information (S17).

When the communication unit 11 of the identification information management apparatus 10 accepts this metadata request, the database management unit 13 of the identification information management apparatus 10 reads the metadata corresponding to the contents ID included in the metadata request from the metadata database 16 and sends this metadata to the contents search apparatus 100 from the communication unit 11. Metadata sent to the contents search apparatus 100 is metadata stored in the metadata table 16A in the metadata database 16 and license data stored in the license data table 16B, as illustrated in FIG. 6. However, if no license data exists even though metadata corresponding to the contents ID included in the metadata request exists, only metadata stored in the metadata table 16A will be sent. Also, if neither of the data exists, they will not be sent.

When the validity determination unit 153 receives the metadata via the communication unit 151 of contents search apparatus 100 (S18), it determines whether the acquisition pattern information indicated by the acquisition pattern information and the usage pattern according to the business description satisfy the condition indicated by the metadata (S19).

For example, if “Company B” is set as the licensee of the sent license data (that is a kind of metadata) and the business name indicated by the submitter address in the acquisition pattern information is “Company B”, then the acquisition pattern information satisfies the condition indicated by the license data that is a kind of metadata. In other word, it is determined that the posting operation of the posted contents data is a posting operation that satisfies the condition indicated by the license data.

If the validity determination unit 153 determines that the acquisition pattern indicated by the acquisition pattern information and the usage pattern according to the business description do not satisfy the condition indicated by the license data that is a kind of metadata (NO at step 19), this posted contents data will be considered illegal, and the illegal details of this posted contents data will be stored in the upload log database 156 (S20). Specifically, the metadata sent from the identification information management apparatus 10 (e.g., a contents ID, a distribution prohibition period, a right holder), the submitter address included in the acquisition pattern information, an acquisition period (i.e., an illegal detecting time), an acquisition media will be stored in this upload log database. Next, the validity determination unit 153 causes this posted contents data to be deleted from the posted-contents file 146 (S21). In this case, the validity determination unit 153 gives a delete instruction to the file management unit 143 of the contents acceptance module 140 and causes the posted contents data to be deleted from the posted-contents file 146. Next, the validity determination unit 153 causes the communication unit 151 to send the user terminal 50 that is the submitter of this posted contents data to an illegal notification indicating that the posting operation of this posted contents data is illegal and a request for deleting the posted contents data (S22). Among the data stored in the upload database 156, at least a contents ID and an acquisition time data are included in the illegal notification sent to this user terminal 50.

The validity determination unit 153 further causes the communication unit 151 to send to the right management apparatus 20 the illegal notification that the posted contents data is illegal (S23). For this posted contents data, all data stored in the upload database 156 are included in this illegal notification. Note that the illegal notification may be sent to a police system or a valid contents owner other than this right management apparatus 20. Also, notification to the right management apparatus 20 may be done not only when an illegal is detected, but also periodically.

With that, the process for the. case where the posted contents data is illegal terminates

On the other hand, if it is determined at step 16 that the acquisition pattern indicated by the acquisition pattern information and the usage pattern according to the business description satisfy the condition indicated by the distribution pattern information, if it is determined at step 19 that they satisfy the condition indicated by the metadata, and further if, though not shown in FIG. 10, the metadata cannot be received from the identification information management apparatus 10, that is, if the identification information management apparatus 10 does not have the metadata corresponding to the contents ID, then the validity determination unit 153 provides a transfer instruction for the file management unit 143 of the contents acceptance module 140 and causes this posted contents data to be transferred to the contents-for-distribution file 126 of the distribution module 120 from the posted-contents file 146 (S24). Then, the validity determination unit 153 causes the communication unit 151 to send, to the user terminal 50 that is the submitter of the posted contents data, a validity notification that the post operation of this posted contents data is valid (S25). With that, the process for the case where the posted contents data is valid terminates Note that it is completely possible to omit the validity notification to the submitter.

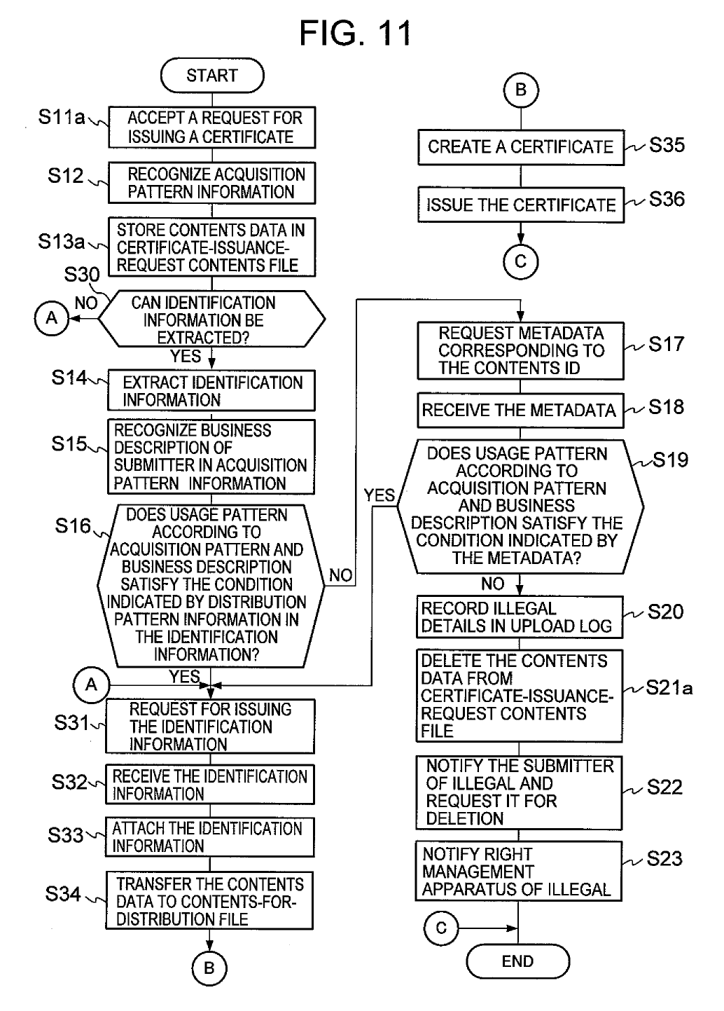

Next, with reference to FIG. 2, the process of issuing a contents certificate will be described in accordance with the flowchart in FIG. 11.

When the user terminal 50 sends to the contents search apparatus 100 this contents data or contents body and the metadata as well as a request for issuing a certificate of the contents body, the communication unit 141 of the contents acceptance module 141 receives them (S11a). The one who created the contents body himself/herself, the one who was validly given the contents body from the contents creator, and a malicious third party are considered as one who requests for issuing a certificate of the contents. For this reason, in this situation, there might be some cases, such as a case where contents body to which identification information has not attached yet as well as a request for issuing a certificate are sent, a case where contents data to which valid identification information has already attached as well as a request for issuing a certificate are sent, and additionally, a case where a contents data to which illegal identification information has already attached as well as a request for issuing a certificate are sent.

In a similar way of step 12 in FIG. 10, the acquisition pattern recognition unit 142 of the communication unit 141 recognizes, on accepting a request for issuing the certificate, the acquisition pattern information of the content body or content data, that is, the submitter address of the contents body or content data, acceptance time (i.e., acquisition time), and the acquisition media (S12). Next, the file management unit 143 of the contents acceptance module 140 receives the contents body or contents data, the metadata and the acquisition pattern information thereof from the communication unit 141, and stores them in the certificate-issuance-request contents file 147 (S13a). It should be understood that although the contents body or contents data and the metadata thereof are stored in the same file, each may be stored in separate files. Furthermore, the file management unit 143 passes the contents body or contents data and the acquisition pattern information thereof stored in the certificate-issuance-request contents file 147 to the contents validity determination module 150.

The identification information extraction unit 154 of the contents validity module 150 extracts identification information from the contents body or contents data passed from the contents acceptance module 140 (S30), and if the identification information cannot be extracted (i.e., NO at step 30) then it proceeds to step 31, otherwise if the identification information can be extracted then it will be extracted (S14).

After extracting the identification information, as discussed below, steps 15 to 23 will be performed in a similar way of steps 15 to 23 shown in the FIG. 10. Therefore, even when a request for issuing a certificate is received, if the contents data received at the time is illegal, the contents data will be deleted from the contents file 147 for the certificate issuance request (S21a), the illegal in the contents data will be notified to the client and deletion of the contents will be requested to the client (S22), and the illegal in the contents will be notified to the right management apparatus 20 (S23).

On the other hand, if the identification information extraction unit 154 determines at step 30 that it cannot extract the identification information, it requests the identification information attachment unit 163 of the certificate issuance module 160 to attach the identification information to the contents body. In this case, the identification information extraction unit 154 causes the file management unit 143 of the contents acceptance module 140 to read the contents body and the metadata thereof from the contents file 147 for the certificate issuance request and to send them to the identification information attachment unit 163. If it is determined at step 16 that the acquisition pattern indicated by the acquisition pattern information and the usage pattern according to the business description satisfy the condition indicated by the distribution pattern information, if it is determined at step 19 that they satisfy the condition indicated by the metadata, and further if, though not shown in FIG. 11, the metadata cannot be received from the identification information management apparatus 10, then the validity determination unit 157 requests the identification information attachment unit 163 of the certificate issuance module 160 to attach the identification information to the contents data. Also in this case, the validity determination unit 157 causes the file management unit 143 of the contents acceptance module 140 to read the contents body and metadata thereof from the contents file 147 for the certificate issuance request and to send them to the identification information attachment unit 163.

The identification information attachment unit 163 that received a request for attaching identification information causes the communication unit 161 to send a request for issuing the identification information to the identification information management apparatus 10 (S31). In this case, the identification information attachment unit 163 causes the communication unit 161 to send to the identification information management apparatus 10 the contents body or the metadata of the contents data as well as this request for issuing the identification information.

The communication unit 11 of the identification information management apparatus 10, on receiving metadata as well as this request for issuing identification information, sends this metadata to the identification information generation unit 14 and, based on this metadata, generates new identification information (shown in the FIG. 7), passes the metadata as well as this identification information to the database management unit 13, and correlates this identification information with the metadata to store them in the metadata database 16. In addition, the identification information generation unit 14 causes the communication unit 11 to send the new generated identification information to the contents detecting apparatus 100 of the client.

When the identification information attachment unit 163 of the certificate issuance module 160 of the contents detecting apparatus 100 receives new identification information from the identification information management apparatus 10 via the communication unit 161 (S32), the new identification information is attached to the contents body or contents data previously received (S33). As a way of attaching this identification information, a method is known in which the identification information embedded in the contents body with digital watermark technique other than a method that the identification information is written into the header of the contents body and, in this embodiment, the former digital watermark technique is employed. It is noted that in this embodiment, even for a valid contents data to which identification information has already been attached, new identification information will be embedded in the contents body. This digital watermark technique is described in Japanese published patent application 2003-319162 and Japanese published patent application 2004-185047, other than the patent document 1 described above. In the former document a technique is disclosed with which digital watermark information is embedded in an image and in the latter document a technique is disclosed with which digital watermark information is embedded in a program. In this manner, the digital watermark techniques can be applied to a wide variety of contents such as moving images, still images, programs, texts, music, and calculated data.

Additionally, the identification information extraction unit 154 of the contents validity determination module 150 described above handles both a case that identification information is written into the header of the contents body and a case that identification information is embedded in the contents body with the digital watermark technique.

When identification information is attached to the contents body or contents data, the identification information attachment unit 163 passes the contents data to which the identification information is attached to the file management unit 123 of the distribution module 120 and causes the contents-for-distribution file 126 to store this contents data (S34). Furthermore, the certificate creation unit 164 creates a certificate for this contents body or contents data (S35). The certificate creation unit 164 extracts a representative diagram from the contents data to which the identification information attached, as shown in FIG. 13, this representative diagram 9, the identification information 1, the registration client 6, the issuance date 7 output from time-stamp unit 165, the certifier 8 who is the manager of the contents search apparatus, are composed to create the certificate C. The certificate creation unit 164 stores data written in this certificate C in the certificate issuance record file 167.

After the certificate C is created, the communication unit 161 of the certificate issuance module 160 sends the certificate C to the client making a request for issuing the certificate (S36).

With that, the process of issuing a certificate for the contents body or contents data requested for issuing the certificate is completed.

Note, here, that although a contents ID, a reproduction permission, a distribution media, and identification information that includes a distribution period are written into the certificate C as contents identification information, because the above information have already been embedded in the targeted contents data and also registered in the identification information management apparatus 10, only the contents ID may be written into the certificate C as identification information. Also, although the date output from the time-stamp unit 165 carried by the certificate issuance module 160 is used as the issuance date 7 here, in order to further enhance the reliability of the issuance date 7, the date output from a certain time-stamp server managed by a third party may be used.

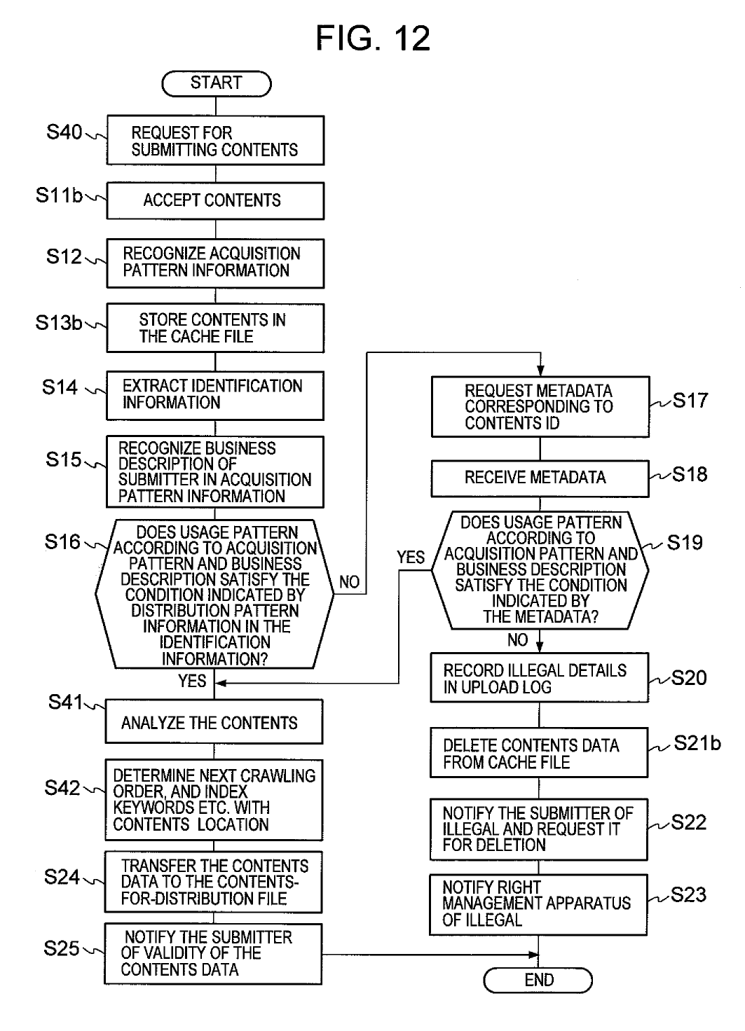

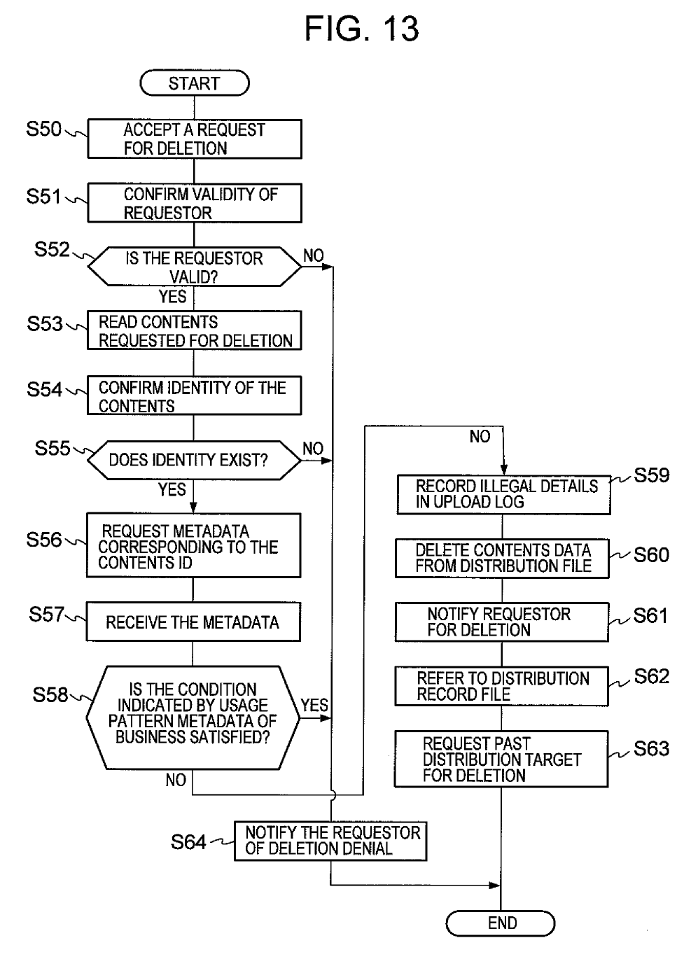

Next, with reference to FIG. 3, a cyclic monitoring process of contents will be described according to the flowchart shown in FIG. 12.

The communication unit 131 of the crawler module 130 crawls multiple contents locations on the network, requests them to submit contents data (S40), and sequentially accepts contents data from them (S11b). A distribution contents file 36 exists within the distribution server 30 and, within the relay server 40 of the distribution server 30, a network cache file 46 exists to which the contents data stored in the distribution content file 36 is copied. Specifically, the communication unit 131 of the crawler module 130 crawls a plurality of the distribution servers 30, 30 and the relay server 40, and requests these servers to submit contents data from the files 36, 36 and 46.

In a similar way of step 12 in FIG. 10 and FIG. 11, the acquisition pattern recognition unit 132 of the communication unit 131 in the crawler module 130 recognizes acquisition pattern information of the contents data, that is, the submitter address of the contents data, acceptance time (i.e., acquisition time), the acquisition media (S12).

The cache control unit 133 of the crawler module 130 receives the content data and the acquisition pattern information thereof from the communication unit 131 and stores them in the cache file 136 (S13b). Additionally, the identification information extraction unit 154 of the content validity determination module 150 receives the content data and the acquisition pattern information thereof from the communication unit 131 of the crawler module 130 and extracts identification information from the contents data (S14).

After extracting the identification information, steps 15 to 23 will be performed in the similar ways of step 15 to 23 in FIG. 10. Therefore, even when the contents data on the network is collected by the crawler module 130, if the collected contents data is illegal, deleting the contents data from the cache file 136 (S21b), sending an illegal notification and a deletion request to the submitter (S22), and sending an illegal notification to the right management apparatus 20 (S23) will be performed. However, preferably, the illegal notification and the deletion request for the submitter at step 22 are performed recursively. In other words, if the contents data that is determined to be illegal has been distributed to the user terminal 50 carrying the distribution server 30 of the submitter etc., it is preferable to perform an illegal notification and deletion request even for this user terminal 50 from the distribution server 30 etc. of the submitter. If there exists a relay server 40 that maintains a copy of the contents data maintained by the distribution server 30 of the submitter, it is preferable to perform a illegal notification and deletion request even for this relay server 40. In this manner, when an illegal notification and deletion request are performed recursively, each distribution servers 30, 40, etc. manages a distribution log of the contents as a file etc. and sends an illegal notification and deletion request to the destination of the illegal contents data with reference to this distribution log.

At steps 16 and 19, it is considered whether the contents usage pattern of the contents submitter satisfies the condition indicated by the distribution pattern information in the identification information or the condition indicated by the metadata. Specifically, if “DVD” is designated as the distribution media and “until Oct. 1, 2008” is designated as a distribution prohibition period in distribution pattern information in the identification information or metadata, when the business description recognized from the submitter address in the acquisition pattern information at step 15 is “network TV” and the acquisition time in the same acquisition pattern information is “Oct. 3, 2007”, although it is almost a year before the distribution prohibition period expires, it is determined that because the contents data is about to be distributed via network media other than DVD, that is, the contents usage pattern is network distribution, so at steps 16 and 19, a usage pattern according to the business description does not satisfy the condition indicated by the distribution pattern information.

On the other hand, if it is determined at step 16 that the acquisition pattern indicated by the acquisition pattern information and the usage pattern according to the business description satisfy the condition indicated by the distribution pattern information, if it is determined at step 19 that they satisfy the condition indicated by the metadata, and further, though not shown in FIG. 12, if the metadata cannot be received from the identification information management apparatus 10, then the content analysis unit 135 of the crawler module 130 determines that the collected contents data is valid, analyzes the contents data stored in the cache file 136 (S41), determines the next crawling order to pass this contents data to the crawling control unit 134 and extracts keywords or feature quantity in the contents data, indexes these keywords or feature quantity with the submitter URL of the contents data, and stores them in the contents index file 116 of the search module 110 (S42).

Furthermore, the validity determination unit 153 causes the cache control unit 133 of the crawler module 130 to transfer the contents data stored in the cache file 136 to the contents-for-distribution file 126 of the distribution module 120 (S24). Then, a process is performed to send a validity notification to the submitter in the same way of step 25 in FIG. 10 etc., and is completed.

Next, with reference to FIG. 3, an operation of the case where a search request is accepted from the user terminal 50 will be briefly described.

For example, assume that certain user terminal 50 specifies a particular keyword and requests the contents search apparatus 100 to search contents related to this keyword. When the communication unit 111 of the search module 110 of the contents search apparatus 100 accepts this search request, the search engine 113 refers to the contents index file 116, acquires the contents location (URL) associated with the keyword included in the search request, and returns it from the communication unit 111 to the search requester, the user terminal 50.

When the user terminal 50 acquires the contents location from the contents search apparatus 100, it sends a contents distribution request to the contents location. If this contents location is the contents search apparatus 100, the communication unit 121 of the distribution module 120 of the contents search apparatus 100 receives it, the file management unit 123 of the distribution module 120 extracts the contents and pass it to the communication unit 121, and causes the user terminal 50 that is the contents distribution requestor to send the contents.

Next, with reference to FIG. 4, the process of accepting a deletion request will be described in accordance with the flowchart illustrated in FIG. 13.

For example, if a user of certain user terminal 50 sees the contents distributed from the contents search apparatus 100 and determines that he/she owns the right for the contents and does not allow it to be distributed by the contents search apparatus 100, he/she will request the contents search apparatus 100 to delete this contents. It may be also the case that a malicious third party sees the contents distributed from the contents search apparatus 100 and requests for deleting the contents simply for the purpose of doing it.

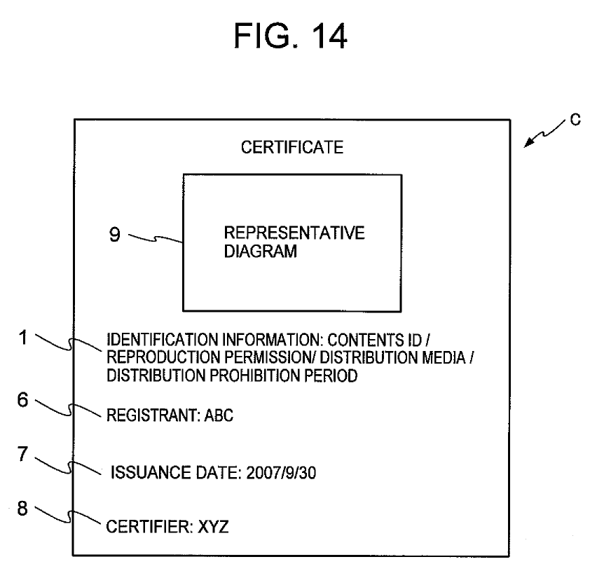

If the user or the malicious third party described above requests for deleting the contents carried by the contents search apparatus 100, for example, a certificate of the contents (illustrated in FIG. 14) is signed using a secret key and this contents certificate as well as the contents deletion request are sent to the contents search apparatus 100.

When the communication unit 171 of the deletion request processing module 170 of the contents search apparatus 100 receives a certificate of the contents as well as a request for deleting the contents (S50), this certificate will be passed to the requestor confirmation unit 174 of the deletion request processing module 170 and to the validity determination unit 173. When the requester confirmation unit 174 receives the contents certificate, it examines its signature using the public key of the deletion requestor and confirms that this deletion requestor is validly qualified for requesting deletion (S51). If this deletion requestor is validly qualified for requesting deletion (YES at S52), the validity determination unit 173 causes the file management unit 123 of the distribution module 120 to read from the contents-for-distribution file 126 the contents data that has a contents ID provided in the contents certificate and receives it (S53).

The validity determination unit 173 compares a representative diagram in the contents certificate with the read contents data and confirms the identity between the representative diagram in the contents requested for deletion and the corresponding part in the read contents data (S54). As a way of this confirmation, for example, a method is known that causes the display of this contents search apparatus 100 to render both data side by side thereon and causes the manager etc. of this contents search apparatus 100 to confirm the identity, in addition to a method that causes an image processing module to extract the difference between the both data and if the difference is found to be less than the predefined threshold then it is determined that there exists identity between the both data. If the identity between the contents data is not clear, that is, if the representative diagram of the contents requested for deletion and the corresponding part of the read contents data do not perfectly match with each other and are slightly different, then because one of the contents requested for deletion and the contents carried by the contents search apparatus 100 might be partly modified from the original one, it will be better to cause the deletion requestor to send the contents data itself that is the target of the deletion request and to compare this contents data with the contents carried by the contents search apparatus 100.

The validity determination unit 173, on confirming the contents identity (YES at S55), sends a request for sending the metadata corresponding to the contents ID in the contents certificate to the identification information management apparatus 10 (S56) and receives the metadata corresponding to this contents ID (S57).

The validity determination unit 173 determines whether the contents usage pattern by the business for this contents search apparatus 100 satisfies the condition indicated by the metadata (S58). If it is determined that the contents usage pattern by the business does not satisfy the condition indicated by the metadata, in other words, if it is determined that the usage pattern of this contents is illegal and the contents deletion request is valid, then the validity determination unit 173 records the illegal detail of the contents data in the upload log database 156 of the contents validity determination module 150 (S59) and causes the file management unit 123 of the distribution module 120 to delete the contents data from the contents-for-distribution file 126 (S60).

Next, the validity determination unit 173 causes the communication unit 171 to notify the deletion requester of the fact that the contents data requested for deletion is deleted (S61). In addition, with reference to the distribution record file 127 of the distribution module 120 (S62), it is determined whether the contents data is distributed, and if the contents data is distributed, the validity determination unit 173 causes the communication unit 171 to notify the distribution target of the deletion request for the contents data (S63).

With that, the process of the case that the contents data requested for deletion is illegal, that is, the deletion request is valid, is completed.

On the other hand, if it is determined at step 52 that the requestor is not valid, if it is determined at step 55 that the contents identity does not exist, and if it is determined at step 57 that the contents usage pattern by the business for the contents search apparatus 100 satisfies the condition indicated by the metadata, then the validity determination unit 173 causes the communication unit 171 to notify the deletion requester of the fact that the deletion request is denied (S64).

Although the process of accepting the deletion request at the contents search apparatus has been described above, it is preferable for not only the contents search apparatus 100 but also each server 30, 40, etc to perform this process.

As described above, in this embodiment, as identification information attached to the contents body, other than a contents ID uniquely identifying the contents body, distribution pattern information specifying the distribution pattern of the contents is included, so that as for a distribution pattern not specified by the distribution pattern information attached to the contents, anyone other than the contents license owner can also acquire a right usage opportunity of this contents while detecting illegal in the contents.

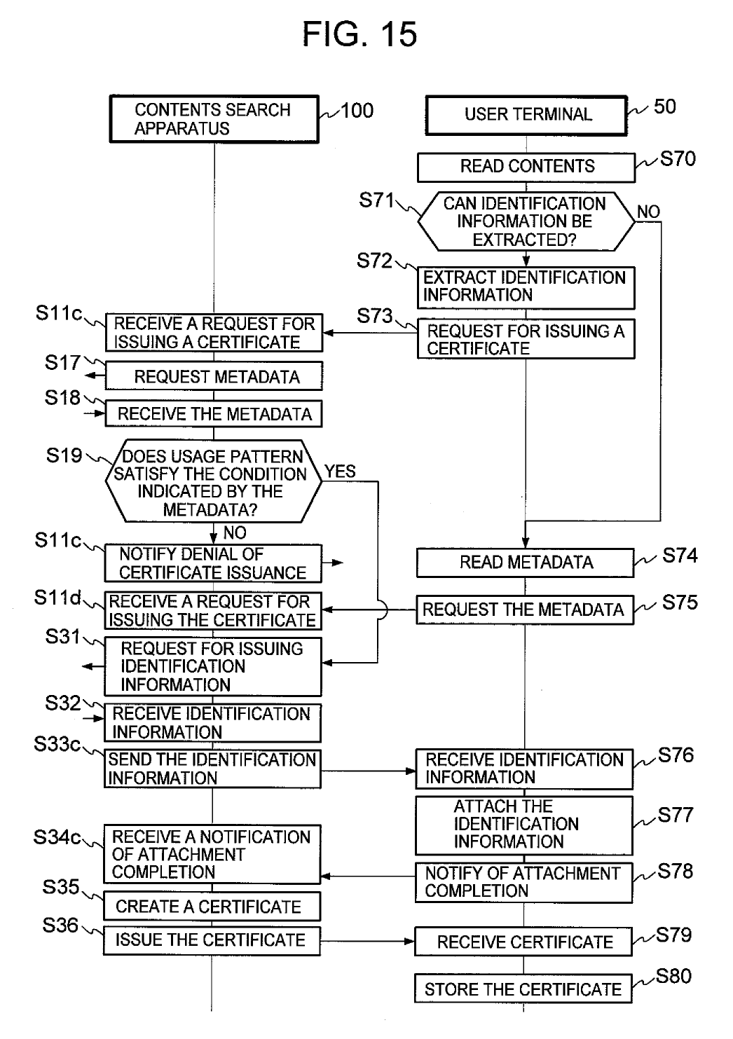

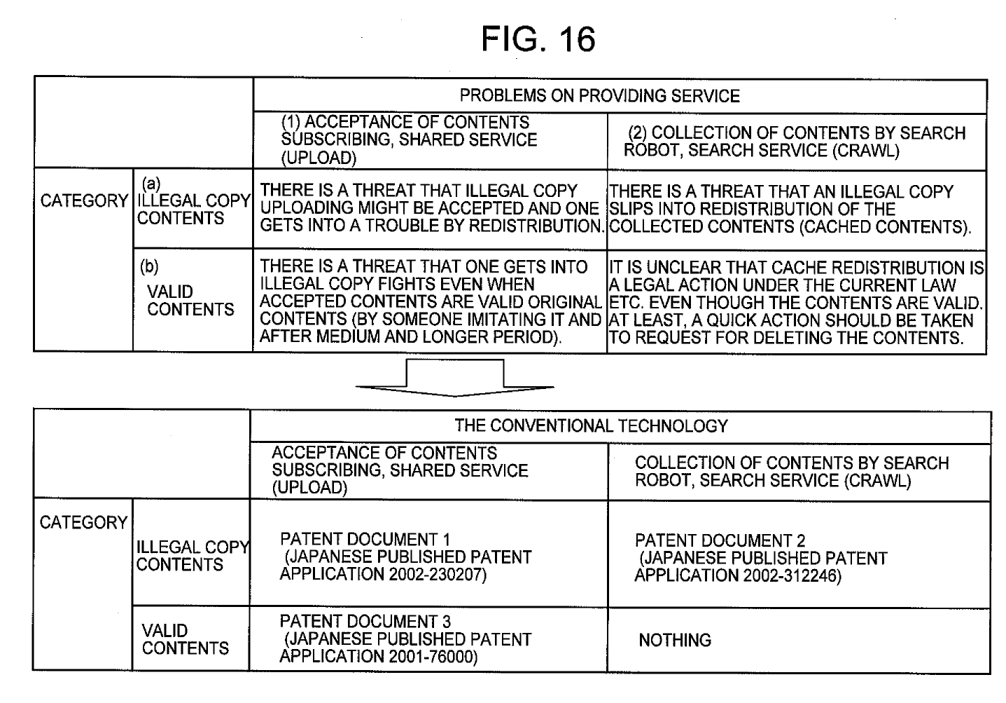

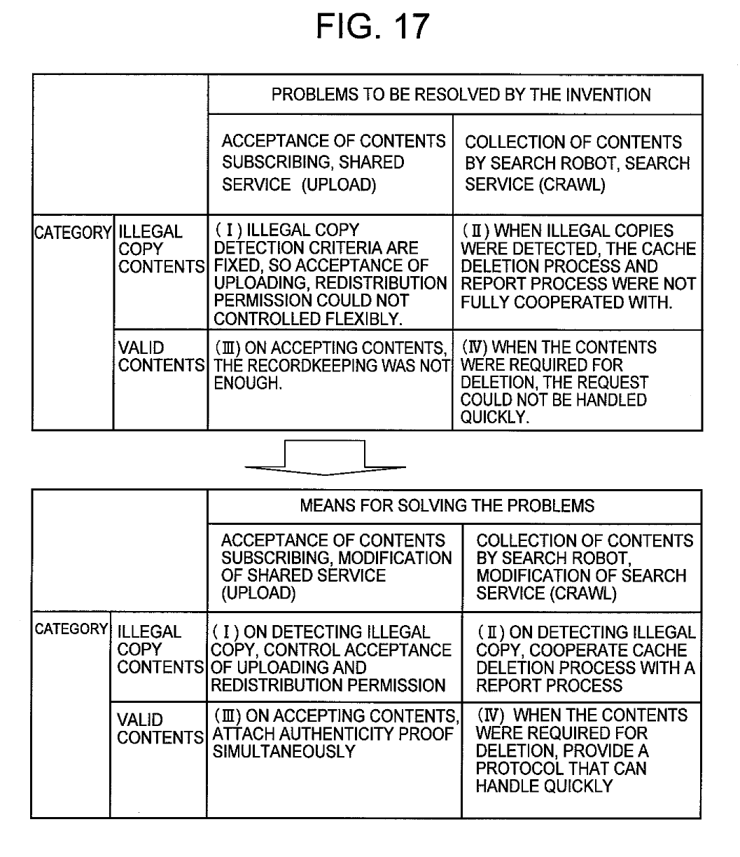

Next, a variant of the process of issuing a contents certificate will be described in accordance with the sequence diagram illustrated in FIG. 15.

In above embodiment, although identification information is attached to the contents data determined to be valid by the identification information attachment unit 163 of the contents search apparatus 100 (shown in FIG. 2), the variant is implemented at user terminal 50 of the certificate issuance requestor. Therefore, in this variant, the identification information attachment unit 163 of the certificate issuance module 160 of the contents search apparatus 100 may be omitted.

First, the CPU of the user terminal 50 reads contents data or a contents body from the contents data storage location (S70) and determines whether identification information can be extracted from the contents data or the contents body (S71). In many cases the identification information cannot be extracted because it is often the case that the identification information has not been attached to the contents body requested for issuing a certificate yet (NO at step 71), and in those cases metadata is read from its storage location (S74) and this metadata as well as the request for issuing a certificate are sent to the contents search apparatus 100 (S75).

Additionally, if contents body in the contents data created by others is modified, identification information can be extracted from the contents data created by them. In this case (YES at step 71), identification information is extracted from this contents data (S72), a request for issuing a certificate of the contents indicated by the identification information as well as the identification information are sent to the contents search apparatus 100 (S73).

When the communication unit 151 of the validity determination module 150 in the contents search apparatus 100 receives this request for issuing a certificate (S11c), the validity determination unit 153 of the validity determination module 150 causes the communication unit 151 to send a request for the metadata corresponding to the contents ID included in the identification information to the identification information management apparatus 10 (S17).

When the validity determination unit 153 receives metadata via the communication unit 151 (S18), it determines whether the contents usage pattern at the certificate requester satisfies the condition indicated by the metadata (S19). If it is determined that the contents usage pattern at the certificate requestor does not satisfy the condition, the validity determination unit 153 causes the communication unit 151 to send notification that certificate issuance is denied to the certificate requestor (S11c). Otherwise, if it is determined that the contents usage pattern at the certificate requestor satisfies the condition, the validity determination unit 153 causes the communication unit 151 to send the metadata as well as the request for issuing identification information to the identification information management apparatus 10 (S31). Also, at the user terminal 50, if identification information cannot be extracted from the read contents data or contents body (NO at step 71), and this metadata as well as a request for issuing a certificate is sent and the contents validity determination module 150 of the contents search apparatus 100 receives them, then the validity determination unit 153 causes the communication unit 151 to send the request for issuing identification information to the identification information management apparatus 10 in a similar fashion (S31).

When the communication unit 151 receives identification information from the identification information management apparatus 10 (S32), the validity determination unit 153 causes the communication unit 151 to send this identification information to the user terminal 50 of the certificate requestor (S33c). In this case, the user terminal 50 will be requested to send a representative diagram of the contents requested for its certificate.

When the CPU of the user terminal 50 receives identification information from the contents search apparatus 100, the identification information is attached to the contents data or contents body that are read at step 70 (S77). As for this attachment method, as described above, a method is known in which the identification information is embedded in the contents body with digital watermark technique other than a method in which the identification information is written into the header of the contents body, and in this variant the former digital watermark technique has been employed.

Next, the CPU of the user terminal 50 reports that attachment of the identification information is completed and, in addition, sends a representative diagram of the contents data to the contents search apparatus 100 (S78).

When the communication unit 161 of the certificate issuance module 160 of the contents search apparatus 100 receives the attachment completion report (S34c), this certificate creation unit 164 of this certificate issuance module 160 creates a certificate (shown in FIG. 14) using the representative diagram sent from the user terminal 50 and this contents metadata and it causes the communication unit 161 to issue this certificate to the user terminal 50 of the certificate requester (S36). When the CPU of the user terminal 50 receives this certificate (S79), this certificate is stored in its storage location, and then the process is completed.

What is claimed is:

1. Contents data comprising a contents body and identification information attached the contents body, wherein;
the identification information contains distribution pattern information containing at least one of distribution period information indicating a distribution prohibition period or a distribution permission period of the contents body and distribution media information specifying a distribution media of the contents body, and a contents identifier for uniquely identifying the contents body, and
a computer:
acquires the contents data;
recognizes contents acquisition pattern information on acquiring the contents data;
extracts identification information containing the distribution pattern information from the acquired contents data; and
compares the recognized contents acquisition pattern information with the distribution pattern information contained in the extracted identification information and determines whether the contents data is valid or illegal, in accordance with whether the contents acquisition information satisfies the condition indicated by the distribution pattern information.

2. The contents data recited in claim 1, wherein the distribution pattern information is attached to the contents body with a digital watermark.

3. A contents illegal-detecting program that detects validity of contents data containing contents body and identification information attached to the contents body, wherein:
the identification information contains distribution pattern information containing at least one of distribution period information indicating a distribution prohibition period or a distribution permission period of the contents body and distribution media information specifying a distribution media of the contents body, and a contents identifier for uniquely identifying the contents body, and
the contents illegal-detecting program is configured to cause a computer to execute the steps of:
acquiring the contents data with a data acquisition means of the computer and storing the contents data in a contents storage area of the computer;
recognizing contents acquisition pattern information on acquiring the contents data at the step of acquiring the contents data;
extracting the identification information from the contents data stored in the contents storage area;
determining validity of whether the contents data is valid or illegal, by comparing the recognized contents acquisition pattern information recognized at the step of recognizing contents acquisition pattern information with the distribution pattern information contained in the identification information extracted at the step of extracting the identification information and in accordance with whether the contents acquisition pattern information satisfies the condition indicated by the distribution pattern information; and
storing a determination result at the step of determining validity in the storage area of the computer.

4. A contents illegal-detecting program that detects validity of contents data containing contents body and identification information attached to the contents body, wherein;
the identification information contains distribution pattern information containing at least one of distribution period information indicating a distribution prohibition period or a distribution permission period of the contents body and distribution media information specifying a distribution media of the contents body and a contents identifier for uniquely identifying the contents body, and
the contents illegal-detecting program is configured to cause a computer to execute the steps of:
extracting the identification information from the contents data stored in a contents storage area of the computer;
determining validity of whether the contents data is valid or illegal, by comparing the contents acquisition pattern information acquired on acquiring the contents data stored in the contents storage area with the distribution pattern information contained in the identification information extracted at the step of extracting the identification information and in accordance with whether the contents acquisition pattern information satisfies the condition indicated by the distribution pattern information; and
storing the determination result at the step of determining validity in the storage area of the computer.

5. The contents illegal-detecting program recited in claim 3, wherein:
the distribution pattern information in the identification information contains the distribution media information;
the contents acquisition pattern information contains submitter information indicating a submitter of the contents data; and
at the step of determining validity, the computer recognizes the business description of the submitter indicated by the submitter information in the contents pattern information from the relationship between the submitter pre-stored in the storage area of the computer and the submitter business description and determines whether the contents data is valid in accordance with whether a distribution media indicated by the distribution media information is utilized with a usage pattern of the contents data corresponding to the business description.

6. The contents illegal-detecting program recited in claim 4, wherein:
the distribution pattern information in the identification information contains the distribution media information;
the contents acquisition pattern information contains submitter information indicating the submitter of the contents data; and
at the step of determining validity, the computer recognizes the business description of the submitter indicated by the submitter information in the contents pattern information from the relationship between the submitter pre-stored in the storage area of the computer and the submitter business description and determines whether the contents data is valid in accordance with whether a distribution media indicated by the distribution media information is utilized with a usage pattern of the contents data corresponding to the business description.

7. The contents illegal-detecting program recited in claim 3, wherein:
the distribution pattern information in the identification information contains the distribution media information;
the contents acquisition pattern information contains an acquisition media name on acquiring the contents body; and
at the step of determining validity, the computer determines whether the contents data is valid in accordance with whether the acquisition media name in the contents acquisition pattern information is that of the distribution media indicated by the distribution media information.

8. The contents illegal-detecting program recited in claim 4, wherein:
the distribution pattern information in the identification information contains the distribution media information;
the contents acquisition pattern information contains an acquisition media name on acquiring the contents body; and
at the step of determining validity, the computer determines whether the contents data is valid in accordance with whether the acquisition media name in the contents acquisition pattern information is that of the distribution media indicated by the distribution media information.

9. The contents illegal-detecting program recited in claim 3, wherein:
the distribution pattern information in the identification information contains the distribution period information;
the contents acquisition pattern information contains an acquisition period of the contents body; and
at the step of determining validity, the computer determines whether the contents data is valid in accordance with whether the acquisition period in the contents acquisition pattern information satisfies a distribution prohibition period or distribution permission period indicated by the distribution period information.

10. The contents illegal-detecting program recited in claim 4, wherein:
the distribution pattern information in the identification information contains the distribution period information;
the contents acquisition pattern information contains an acquisition period of the contents body; and
at the step of determining validity, the computer determines whether the contents data is valid in accordance with whether the acquisition period in the contents acquisition pattern information satisfies a distribution prohibition period or distribution permission period indicated by the distribution period information.

11. The contents illegal-detecting program recited in claim 3, wherein;
the contents acquisition pattern information contains submitter information indicating a submitter of the contents data, and
the contents illegal-detecting program is configured to cause the communication means of the computer to execute the step of:
if the determination result stored in the storage area is illegal, notifying the submitter indicated by the submitter information of the fact that the submitted contents data is illegal, and/or notifying a request for deleting the submitted contents data.

12. The contents illegal-detecting program recited in claim 4, wherein;
the contents acquisition pattern information contains submitter information indicating a submitter of the contents data, and
the contents illegal-detecting program is configured to cause the communication means of the computer to execute the step of:
if the determination result stored in the storage area is illegal, notifying the submitter indicated by the submitter information of the fact that the submitted contents data is illegal and/or notifying a request for deleting the submitted contents data.

13. The contents illegal-detecting program recited in claim 3, wherein;
the contents acquisition pattern information contains submitter information indicating a submitter of the contents data, and
the contents illegal-detecting program is configured to cause the communication means of the computer to execute the step of:
if the determination result stored in the storage area is illegal, notifying the apparatus, which manages relation of right of the contents, of the fact that the contents data submitted by the submitter indicated by the submitter information is illegal and notifying the apparatus of the information containing the submitter information and the identification information.

14. The contents illegal-detecting program recited in claim 4, wherein:
the contents acquisition pattern information contains submitter information indicating a submitter of the contents data and,
the contents illegal-detecting program is configured to cause the communication means of the computer to execute the step of:
if the determination result stored in the storage area is illegal, notifying the apparatus, which manages relation of right of the contents, of the fact that the contents data submitted by the submitter indicated by the submitter information is illegal and notifying the apparatus of the information containing the submitter information and the identification information.

15. The contents illegal-detecting program recited in claim 3, wherein:
the contents illegal-detecting program is configured to cause the computer to execute the step of:
if the determination result at the step of determining validity is illegal, deleting the illegal contents data stored in the contents storage area.

16. The contents illegal-detecting program recited in claim 4, wherein;
the contents illegal-detecting program is configured to cause the computer to execute the step of:
if the determination result at the step of determining validity is illegal, deleting the illegal contents data stored in the contents storage area.

17. A contents illegal-detecting apparatus for detecting validity of contents data comprising a contents body and identification information attached to the contents body, wherein;
the identification information contains distribution pattern information containing at least one of distribution period information indicating a distribution prohibition period or a distribution permission period of the contents body and distribution media information specifying a distribution media of the contents body and a contents identifier for uniquely identifying the contents body, and
the contents illegal-detecting apparatus comprising:
a contents data acquiring means that acquires the contents data;
a contents storage area that stores therein the contents data acquired by the contents data acquiring means;
an acquisition pattern recognizing means that recognizes contents acquisition pattern information on acquiring the contents data by the contents data acquiring means;
an identification information extracting means that extracts identification information containing distribution pattern information from the contents data stored in the contents storage area;
a validity determining means that compares the contents acquisition pattern information recognized by the acquisition pattern recognizing means with the distribution pattern information contained in the identification information extracted by the identification information extracting means and determines validity of whether the contents data is valid or illegal in accordance with whether the contents acquisition pattern information satisfies the condition indicated by the distribution pattern information; and
a result storage area for storing the determination result by the validity determining means.

18. The contents illegal-detecting apparatus recited in claim 17, comprising:
a crawling control means for sequentially acquiring contents data from a plurality of contents data submitter with the contents acquiring means by crawling the plurality of contents data submitters.

19. The contents illegal-detecting apparatus recited in claim 17, comprising:
a contents deleting means for deleting illegal contents data stored in the contents storage area if the determination result by the validity determining means is illegal.

20. The contents illegal-detecting apparatus recited in claim 17, comprising:
an accepting means of a certificate issuance request that accepts contents data and a certificate issuance request for the contents data and stores the contents data in the contents storage area;
a certificate generation means for generating a certificate containing a contents identifier if the determination result by the validity determination means is valid; and
a certificate issuance means for sending the certificate generated by the certificate generation means to the certificate issuance requestor.

21. A contents illegal-detecting method that detects validity of contents data containing a contents body and identification information attached to the contents body, wherein;
the identification information contains distribution pattern information containing at least one of distribution period information indicating a distribution prohibition period or a distribution permission period of the contents body and distribution media information specifying a distribution media of the contents body, and a contents identifier for uniquely identifying the contents body and
a computer executes the steps of:
acquiring the contents data with a data acquisition means of the computer and storing the contents data in a contents storage area of the computer;
recognizing contents acquisition pattern information on acquiring the contents data at the step of acquiring the contents data;
extracting identification information containing distribution pattern information from the contents data stored in the contents storage area;
determining validity of whether the contents data is valid or illegal, by comparing the contents acquisition pattern information recognized at the step of acquiring contents data with the distribution pattern information contained in the identification information extracted at the step of extracting identification information and in accordance with whether the contents acquisition pattern information satisfies the condition indicated by the distribution pattern information; and
storing the determination result at the step of determining validity in the storage area of the computer.
